(19) United States
(12) Patent Application Publication
(10) Pub. No.: US 2024/0016082 A1
(43) Pub. Date: Jan. 18, 2024

(54) Automatic Charging Method and System for Robot, and Robot and Storage Medium

(71) Applicant: SUZHOU CLEVA PRECISION MACHINERY & TECHNOLOGY CO., LTD., Suzhou, Jiangsu Province (CN)

(72) Inventors: Lichao Yuan, Suzhou, Jiangsu Province (CN); Shaoming Zhu, Suzhou, Jiangso Province (CN)

(21) Appl. No.: 18/252,571

(22) PCT Filed: Nov. 20, 2020
(86) PCT No.: PCT/CN2020/130295

§ 371 Date: May 11, 2023

(30) Foreign Application Priority Data
Nov. 13, 2020 (CN) 202011266977.X

(51) Int. Cl. A01D 34/00; G05D 1/02

(52) U.S. Cl. CPC A01D 34/008; G05D 1/0225; G05D 1/0276; G05D 2201/0208; A01D 2101/00

(57) ABSTRACT

A robot automatic charging method includes the steps of: controlling the robot to start working within a working region; when the robot needs to be charged, controlling the robot to move towards a charging station and detecting a strength of a target signal in the working region during the movement of the robot; controlling the robot to adjust its moving direction based on detected changes in the strength of the target signal to control the robot to move towards a guiding device near the charging station; and controlling the robot to move towards the charging station according to the guiding device. A robot automatic charging system, a robot, and a computer-readable storage medium are also disclosed.

### TECHNICAL FIELD

The present disclosure relates to the field of intelligent control, in particular to a robot automatic charging method and system, a robot and a storage medium.

### BACKGROUND

Low repetition rate and high coverage are the goals pursued by traversing robots such as mobile robots for vacuuming, lawn mowing, and swimming pool cleaning. Taking a mobile robot like an intelligent robot mower as an example, the robot mower takes a lawn surrounded by the boundary as the working region for lawn mowing operations, while the outside of the lawn is defined as the non-working region.

In the prior art, the charging system of the robot is mainly composed of a charging station and a boundary line connected to the charging station. When the robot needs to be charged, the robot needs to walk along the boundary line to find a charging pile for connection and charging. In this charging method, the robot searches for the boundary without the principle of proximity. When there are obstacles near the boundary line, the robot needs to randomly search for the boundary line again. Thus, time is wasted, and the power consumption of the robot is increased accordingly.

### SUMMARY

In order to solve the above technical problems, the objectives of the present disclosure are to provide a robot automatic charging method, system, robot, and storage medium.

In order to achieve one of the above objectives of the present disclosure, an embodiment of the present disclosure provides a robot automatic charging method, which includes:
controlling a robot to start working within the working region;
when the robot needs to be charged, controlling the robot to move towards the charging station and detecting the strength of the target signal in the working region during the movement;
controlling the robot to adjust its moving direction based on the detected changes in the strength of the target signal to control the robot to move towards a guiding device near the charging station;
controlling the robot to move towards the charging station according to the guiding device.

Through the above method, the charging path can be planned in real-time through the changes in the position and signal strength of the charging station and robot, the charging time is saved, and the performance of the robot is improved.

As a further improvement of an embodiment of the present disclosure, the strength of the target signal is the strength of the charging station signal or the strength of the electronic boundary line signal.

Due to the diversity of charging methods, which can be wireless or wired, the way signals are sent is also diverse.

As a further improvement of an embodiment of the present disclosure, when the robot needs to be charged, controlling the robot to move towards the charging station and detecting the strength of the target signal in the working region during the movement includes: controlling the robot to move towards the charging station by wireless positioning until it moves into the range covered by the target signal.

Due to the inability to detect signals in areas far from the charging station, wireless positioning is used to plan the charging path and improve the performance of the robot.

As a further improvement of an embodiment of the present disclosure, controlling the robot to adjust its moving direction based on the detected changes in the strength of the target signal to control the robot to move towards a guiding device near the charging station includes:
determining whether the strength of the detected target signal continues to increase,
if so, controlling the robot to move in the current direction;
if not, controlling the robot to move in the direction with the strongest strength of the target signal.
determining whether the strength of the detected target signal continues to increase,
if so, controlling the robot to move in the current direction;
if not, controlling the robot to move in the direction with the strongest signal.

Through the above preferred embodiments, the robot can return to the charging station in the direction of the strongest signal, saving electricity and improving efficiency.

As a further improvement of an embodiment of the present disclosure, the method for controlling the robot to move in the direction with the strongest strength of the target signal includes:
firstly, controlling the robot to stop moving;
then, controlling the robot to rotate in place for one cycle and obtain the strongest signal value within one cycle;
finally, controlling the robot to rotate in place again until the detected signal value is roughly the same as the strongest signal value and stop rotating, and move in the current direction.

Through the above preferred embodiment, the robot can easily and quickly find the direction with the strongest signal, saving the time for returning charging, and improving the performance of the robot.

As a further improvement of an embodiment of the present disclosure, the guiding device is configured as an electronic boundary line, which controls the robot to move towards the charging station based on the guiding device, including: control the robot to move towards the electronic boundary line and then move along the electronic boundary line to the charging station.

Through the above preferred embodiment, it describes the way in which the robot searches for a charging station through electronic boundary lines, improving the performance of the robot.

In order to achieve the other purpose of the above disclosure, an embodiment of the present disclosure provides a robot automatic charging system, which includes a charging station and a robot, after the robot moves into the range covered by the charging station signal through wireless positioning, the robot moves to the charging station along the direction where the signal strength of the charging station becomes stronger.

Through the above system, the charging path can be planned in real-time through the changes in the position and signal strength of the charging station and robot, the charging time is saved, and the performance of the robot is improved.

As a further improvement of an embodiment of the present disclosure, the charging station is set on the electronic boundary line, and after the robot moves into the range covered by the electronic boundary line signal through wireless positioning, the robot moves to the electronic boundary line along the direction where the signal strength of the electronic boundary line becomes stronger and then moves along the electronic boundary line to the charging station.

In order to achieve one of the above disclosure objectives, an embodiment of the present disclosure provides a robot, including a memory and a processor, wherein the memory stores a computer program, and the processor executes the computer program to achieve the steps of the robot automatic charging method as described above.

In order to achieve one of the above disclosure objectives, an embodiment of the present disclosure provides a readable storage medium on which a computer program is stored. When the computer program is executed by a processor, the steps of implementing the robot automatic charging method as described above are implemented.

Compared with existing technologies, the robot automatic charging method, system, robot, and storage medium of the present disclosure can plan the optimal charging path in real-time through the position of the charging station and robot, as well as changes in the signal strength of the charging station or electronic boundary line, enabling the robot to accurately and quickly find the charging station for docking and charging, saving the time for the robot to find the charging station, and thereby increasing the working time of the robot, improving the performance of robots.

### BRIEF DESCRIPTION OF THE DRAWINGS

FIG. 1 is a schematic diagram of an embodiment of the present disclosure;

FIG. 2 is a schematic flowchart of the robot automatic charging method provided in an embodiment of the present disclosure;

FIG. 3 is a schematic flowchart of a robot automatic charging method according to a preferred embodiment of the present disclosure;

FIG. 4 is a schematic flowchart of a robot automatic charging method provided by a specific example according to a preferred embodiment of the present disclosure;

### DETAILED DESCRIPTION OF THE EMBODIMENTS

The following will provide a detailed description of the present disclosure in conjunction with the various embodiments shown in the accompanying drawings. However, these embodiments do not limit the present disclosure, and any structural, method, or functional changes made by those of ordinary skill in the art based on these embodiments are included within the protection scope of the present disclosure.

The robot system of the present disclosure can be a robot mower system, a sweeping robot system, a snow sweeper system, a leaf suction machine system, a golf course ball picker system, etc. Each system can automatically move in the working region and perform corresponding work. In the specific example of the present disclosure, the robot mower system is taken as an example for detailed description, and correspondingly, the working region can be a lawn.

A robot mower system typically includes: a robot mower (RM) and a charging station. The robot mower includes a body, a moving unit and a control unit arranged on the body. The moving unit is used to control moving, steering, etc. of the robot; the control unit is used to plan the moving direction and moving path of the robot, store external parameters acquired by the robot, process and analyze the acquired parameters, and specifically control the robot according to the processing and analyzing results; The control unit is, such as MCU or DSP, etc. The robot and the charging station can be charged by docking the chip or pin, or by wireless charging, which will not be described in detail here. It should be noted that the robot mower of the present disclosure also includes a wireless positioning device, which can be used in various ways, such as GPS positioning, UWB positioning, or Zigbee positioning, etc. With the GPS positioning device, the present disclosure can record the position of the charging station and the position of the robot, and the coordinates recorded can be in various ways, such as using coordinates in electronic maps.

The robot mower of the present disclosure can further optionally include: a camera device and an electronic boundary line recognition device in cooperation with a control unit, wherein the camera device is used to acquire a scenario within a certain range of its viewing angle, and the camera device of the present disclosure is mainly used to identify a charging station; for example, the camera device identifies the position of the charging station by means of image analysis; the electronic boundary line recognition device is mainly used to identify electronic boundary lines; for example, identify electronic boundary lines connecting charging stations by means of electromagnetic induction; furthermore, the control unit is combined with GPS positioning device, camera device, and electronic boundary line recognition device to control the robot to search for the charging station and plan the optimal path from the current position to reach the charging station position; which will be described in detail below.

In addition, the robot also includes various sensors, storage modules, such as EPROM, Flash or SD cards, as well as working mechanisms for work, and power supply; in this embodiment, the working mechanism is a lawn mower disc, and the various sensors for sensing moving state of the moving robot, such as tipping, off-ground, collision sensors, geomagnetism, gyroscopes, etc., are not specifically described here.

As shown in FIG. 1, the robot mower 4 is equipped with a GPS signal antenna 5. The robot mower 4 is powered by a battery and operates in the working region 3. When the power of the battery is low, the robot mower 4 searches for a charging station 1 to dock and charge. After the power of the battery is fully charged, it returns to the working region 3 to continue working. The charging docking method can be done by inserting a chip or a pin, and the charging method can be wireless charging or wired charging. In the embodiment of the present disclosure, a wired charging method is used. The charging station 1 is set on the electronic boundary line 2, and the mobile robot 4 moves along the electronic boundary line to the charging station after reaching the electronic boundary line 2 to achieve docking charging with the charging station.

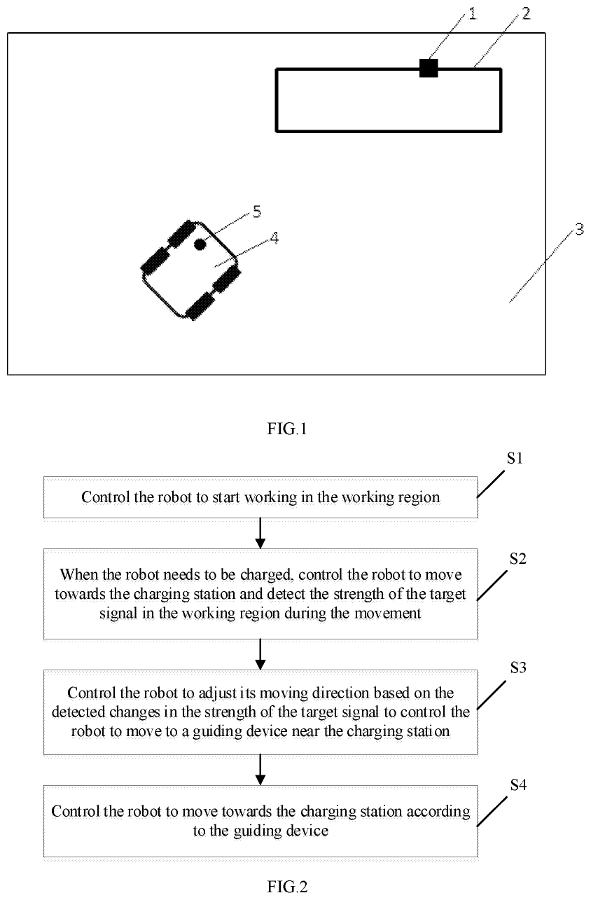

As shown in FIG. 2, an embodiment of the present disclosure provides a robot automatic charging method, which comprises the following steps:
S1. Control the robot to start working in the working region;
S2. When the robot needs to be charged, control the robot to move towards the charging station and detect the strength of the target signal in the working region during the movement;
S3. Control the robot to adjust its moving direction based on the detected changes in the strength of the target signal to control the robot to move towards a guiding device near the charging station;
S4. Control the robot to move towards the charging station according to the guiding device.

For step S2, when the robot works, a charging instruction is issued to the robot by determining various rules. The rules are, for example: the available time of the battery is less than a certain value, the power of the battery is less than a certain value, and the working time of the robot reaches a certain value; when the robot receives a charging instruction, it will calculate the position coordinates of the charging station and the current position coordinates of the robot through the wireless positioning system, and then control the robot to move towards the charging station. However, due to the difficulty of the wireless positioning system in accurately positioning, the robot cannot accurately locate the charging station. Therefore, while the robot moves towards the charging station, it synchronously detects signals in the working region, When the robot moves into the range covered by the charging station or the electronic boundary line signal, it can detect the signal and assist the robot in accurately finding the charging station based on the detected changes in the strength of the signal.

For step S2, there are various ways to control the robot to move towards the charging station, such as positioning in electronic maps, positioning through GPS, UWB, or Zigbee, etc.; in the specific example of the present disclosure, the robot completes initialization at the charging station and records the current longitude and latitude coordinates of the charging station through GPS for subsequent calculation call; in other embodiments of the present disclosure, it is also possible to locate a position with a fixed distance from the charging station and obtain the position coordinates of the charging station through calculation.

For step S3, the signal strength of the charging station or electronic boundary line detected by the robot at a distance away from the charging station is weaker, and the farther it is, the weaker it becomes. If it exceeds a certain distance, the signal may not be detected. As the robot moves towards the charging station position, the strength of the detected signal will gradually increase. The closer it is to the charging station position or the closer it is to the electronic boundary line, the stronger the strength of the detected signal. In an embodiment of the present disclosure, due to the different arrangement shapes of the electronic boundary lines, the moving path of the robot is not fixed, and the strength of the electronic boundary line signal detected during the movement process will change. In order to enable the robot to quickly and efficiently move towards the charging electronic boundary line when returning to the charging station, the method adopted in the present disclosure is to control the robot to adjust its moving direction based on the strength changes of the detected signal, it is that make the robot move in the direction of stronger signals, it can shorten the time it takes for the robot to reach the charging station and save electricity.

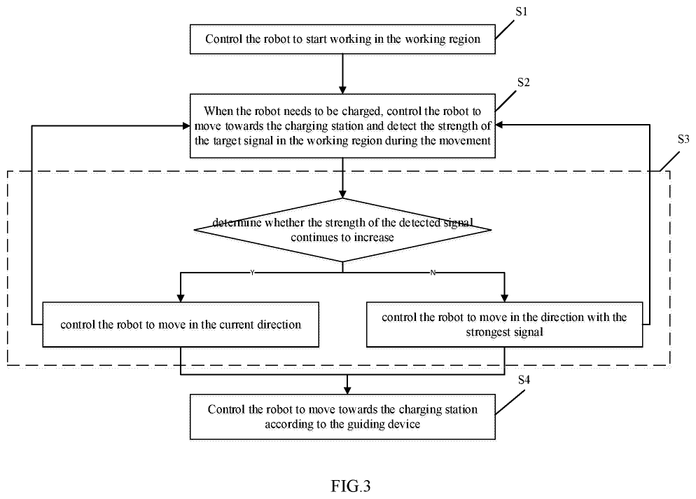

Specifically, as shown in FIG. 3, step S3 further comprises: determine whether the strength of the detected signal continues to increase; if so, control the robot to move in the current direction; if not, control the robot to move in the direction with the strongest signal. When the robot moves in the direction of the charging station, the closer it is to the electronic boundary line of the charging station, the stronger the detected electronic boundary line signal. Therefore, when the strength of the detected electronic boundary line signal becomes strongest, it indicates that the robot is moving in the direction of the closest electronic boundary line to the robot, which is the optimal direction of movement, So keeping the robot moving in its current direction can make it more efficient and precise to travel to the electronic boundary line. When the detected electronic boundary line signal begins to weaken, it indicates that the robot is not in the optimal direction of movement. Therefore, it is necessary to adjust the robot to continue moving in the optimal direction, that is, to continue moving in the direction with the strongest detected signal strength. There are various adjustment methods available here. Cycle through steps S2 to S3 until the robot reaches the guiding device near the charging station. In the embodiment of the present disclosure, the guiding device is the charging electronic boundary line, which can also be other guiding devices. Finally, execute step S4 to control the robot to move along the electronic boundary line and reach the charging station and dock with the charging station to achieve charging.

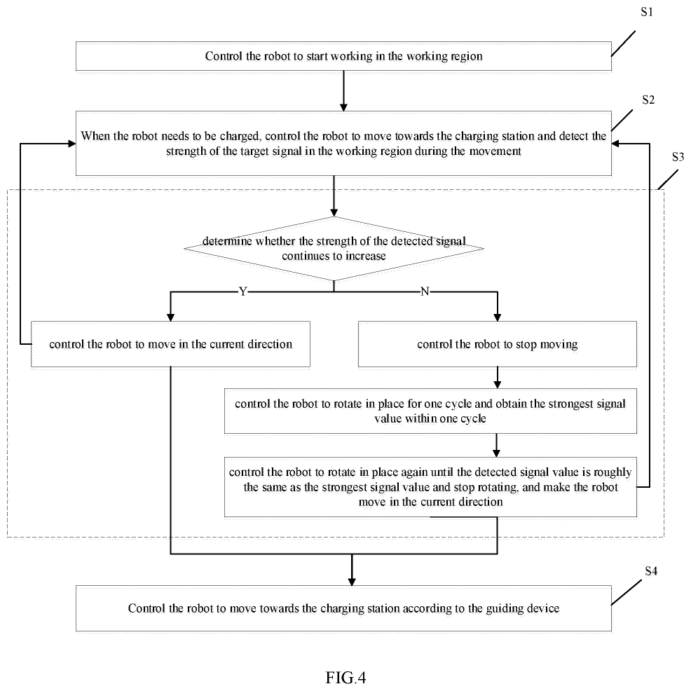

More specifically, as shown in FIG. 4, step S3 in one of the preferred embodiments includes: determine whether the detected signal strength continues to increase; If so, control the robot to keep moving in the current direction; If not, control the robot to stop moving, then control the robot to rotate in place for one cycle and obtain the strongest signal value within one cycle, then control the robot to rotate in place again until the detected signal value is roughly the same as the strongest signal value and stop rotating, and make the robot move in the current direction. When it is detected that the strength of the electronic boundary signal no longer continues to become stronger but begins to weaken, firstly control the robot to stop moving; secondly, control the robot to rotate clockwise or counterclockwise in place for one cycle, synchronously detect and record the signal size values during the rotation process, and obtain the strongest signal value maxSignal; then, rotate the robot clockwise or counterclockwise again and synchronously detect the signal size value. When the detected signal size value is equal to or closest to the value maxSignal, stop rotating which indicates that currently it has rotated to the direction with the strongest signal. Control the robot to continue moving in this direction. Due to the possibility of some accuracy or computational errors in practice, it is difficult to ensure that the detected signal values always remain exactly the same, so the values should be roughly close. Cycle through steps S2 to S3 until the robot reaches the electronic boundary line, and then execute step S4 to control the robot to move along the electronic boundary line and reach the charging station to dock with the charging station to achieve charging.

In an embodiment of the present disclosure, there is also provided a robot automatic charging system, which includes a charging station and a robot. After the robot moves into the range covered by the charging station signal through wireless positioning, the robot moves to the charging station along the direction where the signal strength of the charging station becomes stronger. If the charging station is set on the electronic boundary line, the robot moves into the range covered by the electronic boundary line signal through wireless positioning, and then moves to the charging station along the direction where the signal strength of the electronic boundary line becomes stronger. Technicians in the field can clearly understand that for the convenience and conciseness of the description, the specific working process of the system described above can refer to the corresponding process in the aforementioned method implementation, and will not be repeated here.

In an embodiment of the present disclosure, there is also provided a robot comprising a memory and a processor, wherein the memory stores a computer program, and the processor executes the computer program to implement the steps of the robot automatic charging method described in any of the aforementioned embodiments.

In one embodiment of the present disclosure, there is also provided a readable storage medium, on which a computer program is stored. When the computer program is executed by a processor, the steps of implementing the robot automatic charging method described in any of the in any of the aforementioned embodiments are implemented.

In summary, the robot automatic charging method and system of the present disclosure, as well as the robot and storage medium, can plan the charging path in real-time through the position of the charging station and the robot, save charging time, and improve the performance of the robot.

In the embodiment provided in this application, it should be understood that the disclosed modules, systems, and methods can all be implemented through other means. The system embodiment described above is only schematic, and the division of the modules is only a logical functional division. In actual implementation, there may be other division methods, such as multiple modules or components that can be combined or integrated into another system, or some features that can be ignored or not executed.

The modules described as separate components may or may not be physically separated, and the components displayed as modules may or may not be physical modules, that is, the components may be located at one place or may also be distributed on a plurality of network modules. Some or all of the modules can be selected according to actual requirements to achieve the objective of the solution in this embodiment.

In addition, each functional module in each implementation of the present application can be integrated into a single processing module, or each module can exist physically separately, or two or more modules can be integrated into one module. The integrated modules mentioned above can be implemented in both hardware and software functional modules.

Finally, it should be noted that the above embodiments are only used to illustrate the technical solutions of the present application, but not to limit them; although the present application is described in detail with reference to the foregoing embodiments, those of ordinary skill in the art should understand that modifications can still be made to the technical solutions described in the foregoing embodiments, or equivalent substitutions can be made to some of the technical features; and these modifications or substitutions do not make the essence of the corresponding technical solutions deviate from the spirit and scope of the technical solutions of the embodiments of the present application.

1. A robot automatic charging method, comprising the steps of:
controlling the robot to start working within a working region;
when the robot needs to be charged, controlling the robot to move towards a charging station and detecting a strength of a target signal in the working region during the movement of the robot;
controlling the robot to adjust its moving direction based on detected changes in the strength of the target signal to control the robot to move towards a guiding device near the charging station; and
controlling the robot to move towards the charging station according to the guiding device.

2. The robot automatic charging method according to claim 1, wherein the strength of the target signal is a strength of a charging station signal or a strength of a electronic boundary line signal.

3. The robot automatic charging method according to claim 1, wherein when the robot needs to be charged, controlling the robot to move towards the charging station and detecting the strength of the target signal in the working region during the movement comprises controlling the robot to move towards the charging station by wireless positioning until it moves into the range covered by the target signal.

4. The robot automatic charging method according to claim 1, wherein the step of controlling the robot to adjust its moving direction based on the detected changes in the strength of the target signal to control the robot to move towards a guiding device near the charging station comprises:
determining whether the strength of the detected target signal continues to increase,
if so, controlling the robot to move in the current direction;
if not, controlling the robot to move in the direction with the strongest strength of the target signal.

5. The robot automatic charging method according to claim 4, wherein the step of controlling the robot to move in the direction with the strongest strength of the target signal comprises:
firstly, controlling the robot to stop moving;
then, controlling the robot to rotate in place for one cycle and obtain the strongest signal value within one cycle; and
finally, controlling the robot to rotate in place again until the detected signal value is roughly the same as the strongest signal value and stop rotating, and move in the current direction.

6. The robot automatic charging method according to claim 1, wherein the guiding device is configured as an electronic boundary line, which controls the robot to move towards the charging station based on the guiding device, comprising:
controlling the robot to move towards the electronic boundary line and then move along the electronic boundary line to the charging station.

7. A robot automatic charging system comprising:
a charging station and a robot,
wherein after the robot moves into a range covered by a signal of the charging station through wireless positioning, the robot moves to the charging station along the direction where the signal strength of the charging station becomes stronger.

8. The robot automatic charging system according to claim 7, wherein the charging station is set on an electronic boundary line, and after the robot moves into the range covered by the electronic boundary line signal through wireless positioning, the robot moves to the electronic boundary line along the direction where the signal strength of the electronic boundary line becomes stronger and then moves along the electronic boundary line to the charging station.

9. A robot comprising a memory and a processor, the memory storing a computer program, wherein the processor executes the computer program to achieve the steps of the robot automatic charging methods of claim 1.

10. A computer-readable storage medium on which a computer program is stored, wherein the steps of implementing the robot automatic charging method in claim 1 are implemented when the computer program is executed by a processor.
